(19) United States
(12) Patent Application Publication
(10) Pub. No.: US 2024/0032522 A1
(43) Pub. Date: Feb. 1, 2024

(54) Replaceable Floating Attractant Accessories for Fishing Line

(71) Applicant: Russell Lewis McCurdy, East Helena, MT (US)

(72) Inventor: Russell Lewis McCurdy, East Helena, MT (US)

(21) Appl. No.: 18/380,103

(22) Filed: Oct. 13, 2023

Related U.S. Application Data
(63) Continuation of application No. PCT/US2022/028798, filed on May 11, 2022.
Application No. PCT/US2022/028798 is a continuation of application No. 29/829,126, filed on Mar. 3, 2022.
Application No. 29/829,126 is a continuation of application No. 29/838,106, filed on May 10, 2022.
(60) Provisional application No. 63/187,268, filed on May 11, 2021.

(51) Int. Cl. A01K 85/00; A01K 85/01; A01K 93/00

(52) U.S. Cl. CPC A01K 85/1867; A01K 85/015; A01K 93/00; A01K 85/1853

(57) ABSTRACT

A colored/glow attractant in a spiral or helical shape that may be added to fishing line at any desired point in the length of the line without the necessity of cutting the fishing line. The invention provides convenience in the ability to change colors or glow materials without cutting the fishing line, tying knots, or fumbling around with additional parts. Attachment and removal of the device will not damage the fishing line or the device and will be achieved by winding the fishing line in the spaces between the turns or coils of the spiral, spherical, or helical device. This device is free to slide along the line after being wound around the fishing line. The spiral device itself is made of flexible or rigid filament. This filament may be plastic, nylon, silicon or other materials in either solid material or a hollow tube of illuminating substance of small diameter.

### CROSS-REFERENCE TO RELATED APPLICATIONS

This patent application is a bypass continuation of the currently pending, PCT/US2022/28798 filed on May 11, 2022 which claims priority under 35 U.S.C. § 119(e) to U.S. Patent Application Ser. No. 63/187,268 filed on May 11, 2021, each of which is entitled “Replaceable Floating Attractant Accessories for Fishing Line.” This application claims further priority under 35 U.S.C. § 120 and is a continuation-in-part of U.S. patent application Ser. No. 29/829,126 (filed Mar. 3, 2022) and 29/838,106 (filed May 10, 2022), each entitled “Fishing Attractant”. The entire disclosures of the PCT and provisional patent application, and design patent applications are hereby incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### 1. FIELD OF THE INVENTION

This invention relates to fishing line accessories, and more particularly to such a device for providing colorant or glow attractant with easy attachment and detachment to fishing line.

### 2. DESCRIPTION OF THE RELATED ART

Glow and color attractant beads have been in common use for many years. Typically, the ends of the fishing line are not free to thread through the colored/glow attractant (predominantly beads) and hence the fishing line must be cut in order to add colored/glow attachments such as beads.

Metal springs such as those in U.S. Pat. No. 4,117,619 have been used for fishing lines to weight the lines in place of split shot weights that crimped onto the line similar to those disclosed in U.S. Pat. No. 2,257,415. However, the crimping of the weight onto the line damages the line and the weight of the metal causes the spring to sink to the bottom. Furthermore, these springs are used merely for weighting the line and not for attracting fish.

A removable fishing bead, such as that described in US2014/0157652 A1, has attempted to apply glow and color attractant that will float and remain near the bait yet be easy to install and uninstall. However, the removable bead described in US2014/0157652 A1 is a round bead with a straight slit opening which receives the fishing line and can only hold the line in place after an additional “projection” is also inserted into the opening. The small size of the “projection” object can make this a tedious and time-consuming installation process.

### BRIEF SUMMARY OF THE INVENTION

A coiled, colored or glow-receiving fishing attractant device is provided for attachment to a fishing rig along the length of the line without cutting or tying the fishing line. The configuration of the device is spiral, or helical in nature. The colored/glow attractant device is attached to a fishing line, or removed from a fishing line, by winding the fishing line in the spaces between the turns or coils of the spiral or helix. The device is formed of flexible or rigid, solid or hollow filament with buoyant or semi-buoyant characteristics. The structure floats, hangs, or is partially suspended in a body of water via its attachment to the fishing line. The configuration of the coil creates an interior channel with a diameter that is larger than the fishing line thereby permitting the device the ability to freely slide along a section of fishing line and be applied or removed, and later, reapplied. The diameter of the device abuts the fishing hook or lure to define the relative range of distal movement of the device along the fishing line and relative placement above the bait or other lure. Either the tip of the fishing pole, or an intervening fishing implement such as a sinker defines the proximal range of travel for the attractant device. Various embodiments of the device will be a spiraled coil in the general shape of a cone, a columnar tube, or a variable diameter spring-like sphere or helix where the central portion is desirably of larger diameter than the diameter of either end portion of the spiral.

The present invention is useful for fishing, particularly fishing techniques that implement colored or glowing or glow-charged attractants in proximity to the bait or lure. Typically, when implementing the glow or attractant fishing techniques, the ends of the fishing line are not free to thread through the colored/glow attractant (predominantly beads) and hence the fishing line must be cut in order to add colored/glow attachments, such as beads, before reattaching the hook. The present invention enhances those fishing techniques by permitting quick and easy attachment and detachment of colored/glow from an otherwise rigged fishing line. In use, the colored/glow attractant in a sphere, spiral, or helical shape is added to fishing line at any desired point in the length of the line. It permits this attachment modality without the necessity of cutting or otherwise damaging the fishing line or harming the attractant device itself. No other fishing implements need be removed from the fishing line for installation, use, or removal of the attractant device. The hook, any lures, bait, or sinker may remain in place while the present invention is installed or uninstalled. Because the present invention provides convenience in the ability to change colors or glow materials without cutting the fishing line, tying knots, or fumbling around with additional parts, it will decrease waste, increase efficiency, and result in more line-in-water fishing time.

Attachment and removal of the device, without damage to the fishing line or the device, is achieved by weaving a small, mid-span section of the fishing line in the spaces between the turns or coils of the spiral or helical device. Once installed, the device is free to slide along the line as its body is wound around the fishing line. It is retained on the line in a reliable manner and only removed or replaced by the fisherman when new glow or alternative attractants are desired. The device may have its range of sliding or slipping action on the line be abutted by sinkers or the hook or bait. The device operates to catch the attention of a fish in order to draw it toward the bait.

More specifically, and in a presently preferred embodiment, by way of example and not necessarily by way of limitation, the spiral device itself is made of pliable, flexible, or rigid filament. This filament may be plastic, nylon, silicon, or other materials in either solid material or a hollow tube of an illuminating substance of small diameter.

The present invention fills the need for glow and color attractant that will float and remain near the bait yet be easy to install and uninstall. The quick replacement of the device permits the fisherman to make moment by moment fishing decisions to lure fish to take the baited hook. Glow can be quickly recharged such as by use of a UV charger, or alternative colors applied such as with an alternative-colored device.

The device of the present invention enhances implementation of additional fishing techniques by providing convenient changes of colors or glow materials. This invention is capable of being attached quickly to and detached quickly from the fishing rig at any desired point along the length of the line whereafter the device slides freely along the section of line as the line is captured within the interior channel of the spiral body itself. Other parts of the fishing rig will set the parameters of the sliding range for the attractant device.

The foregoing has outlined, in general, the physical aspects of the invention and is to serve as an aid to better understanding the more complete detailed description which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### BRIEF DESCRIPTION OF THE DRAWINGS

The following drawings further describe by illustration, the advantages and objects of the present invention. Each drawing is referenced by corresponding figure reference characters within the “DETAILED DESCRIPTION OF THE INVENTION” section to follow.

FIG. 1 is a side view of an exemplary embodiment of the floating attractant device shown fully installed on a fishing line and in use within a body of water.

FIG. 2 is an isometric view of a helix-shaped attractant according to the present invention having a generally conical shape.

FIG. 3 is a first side view of FIG. 2.

FIG. 4 is a front view of FIG. 2.

FIG. 5 is a back view of FIG. 2.

FIG. 6 is a second side view of FIG. 2.

FIG. 7 is a first end view of FIG. 2.

FIG. 8 is a second end view of FIG. 2.

FIG. 9 is a side view of the device embodiment illustrated in FIG. 2 with the device shown in its initial stage of installation onto a fishing line.

FIG. 10 is a side view of the device embodiment illustrated in FIG. 2 showing full installation onto a fishing line.

FIG. 11 is an isometric view of another embodiment of the present invention illustrating a helix-shaped attractant invention with uniform diameter.

FIG. 12 is a first side view of the embodiment illustrated in FIG. 11.

FIG. 13 is a second side view of the embodiment illustrated in FIG. 11.

FIG. 14 is a front view of the embodiment illustrated in FIG. 11.

FIG. 15 is a back view of the embodiment illustrated in FIG. 11.

FIG. 16 is a first end view of the embodiment illustrated in FIG. 11.

FIG. 17 is a second end view of the embodiment illustrated in FIG. 11.

FIG. 18 is a front view of the embodiment illustrated in FIG. 11 with the device shown installed on a fishing line.

FIG. 19 is a front view of the embodiment as illustrated in FIG. 11 shown fully installed on a fishing line and in use within a body of water.

FIG. 20 is an isometric view of yet another embodiment of the attractant device with a varied diameter spring-like helix where the center portion is desirably of larger diameter than the diameter of either end portion.

FIG. 21 is a front view of the embodiment illustrated in FIG. 20.

FIG. 22 is a back view of the embodiment illustrated in FIG. 20.

FIG. 23 is a first side view of the embodiment illustrated in FIG. 20.

FIG. 24 is a second side view of the embodiment illustrated in FIG. 20.

FIG. 25 is a first end view of the embodiment illustrated in FIG. 20.

FIG. 26 is a second end view of the embodiment illustrated in FIG. 20.

FIG. 27 is a front view of the embodiment illustrated in FIG. 20 with the device shown installed on a fishing line.

FIG. 28 is a front view of the embodiment as illustrated in FIG. 20 shown fully installed on a fishing line and in use within a body of water.

### DETAILED DESCRIPTION OF THE INVENTION

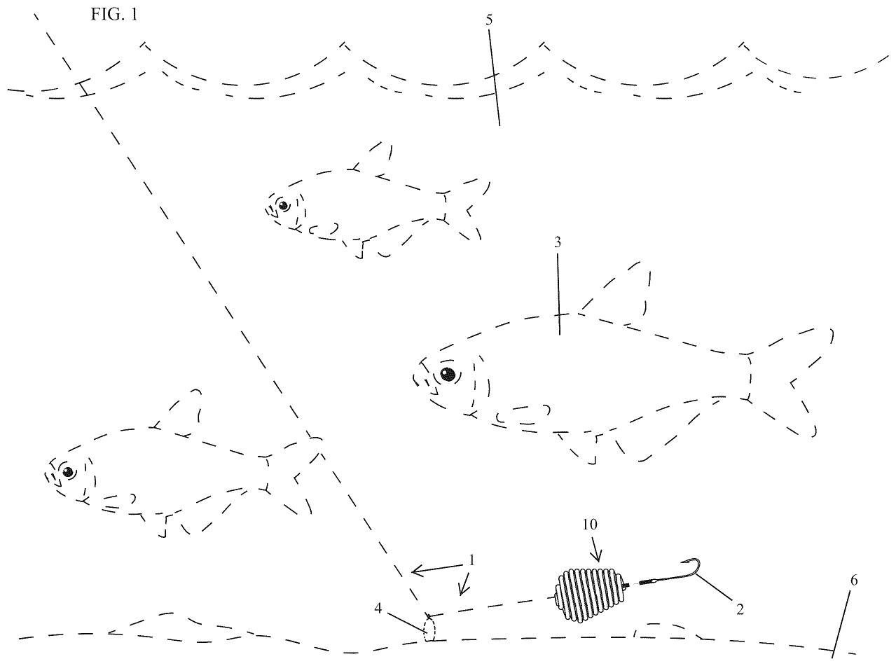

The attractant of the present invention relates to fishing, particularly colored/glow attractants capable of being quickly and easily attached to and detached from a fishing line usually in proximity to the already attached hook 2, bait or lure. The configuration of the device is generally that of a coil, spiral, or helix of various shapes including, for example, a cylinder, sphere, or cone. With reference to FIG. 1, colored/glow attractants 10 of the present invention are attached to a fishing line 1, or removed from a fishing line 1, by winding the fishing line 1 into the spaces between the turns or coils of the spiral or helical device. As represented generally in FIG. 1, in combination with a fishing line 1 rigged with fishing tackle such as sinkers 4 and a hook 2, the fishing rig including the device 10 of the present invention is cast into a body of water 5 to attract fish 3. This device 10 is free to slide along the section of line 1 between the sinker 4 and the hook 2 after being wound around the fishing line. As shown in FIG. 1, because the device 10 is made of buoyant or semi-buoyant material, it will aid in floating the bait on the hook 2 or lure above the floor 6 of the body of water 5.

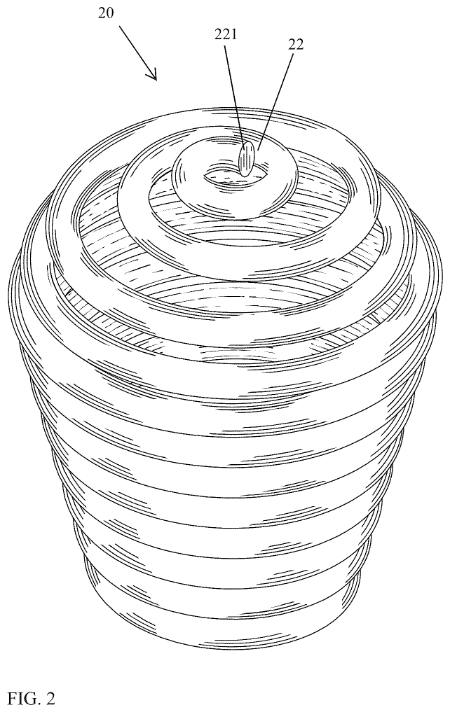

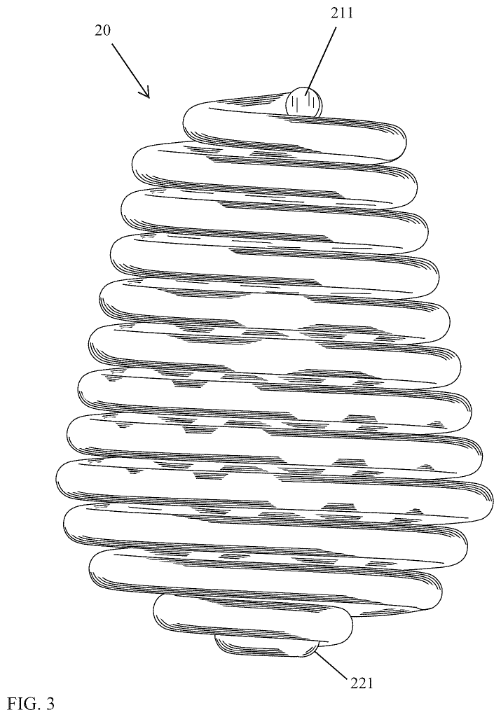

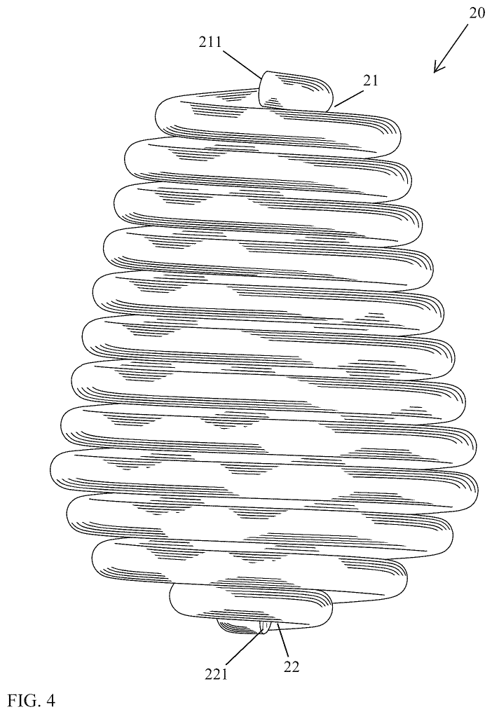

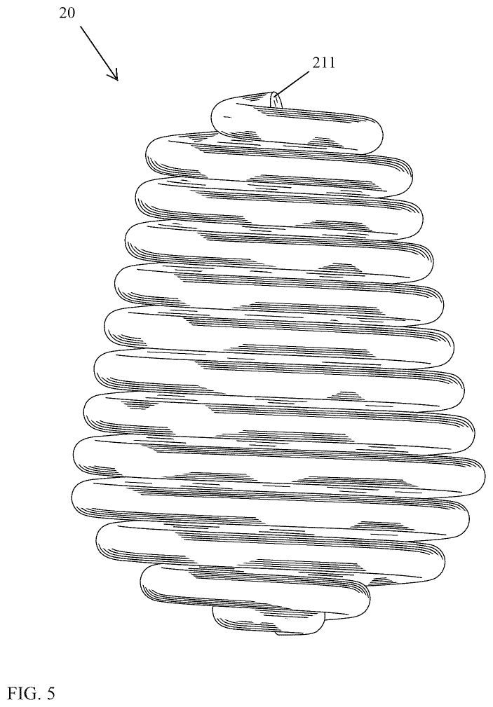

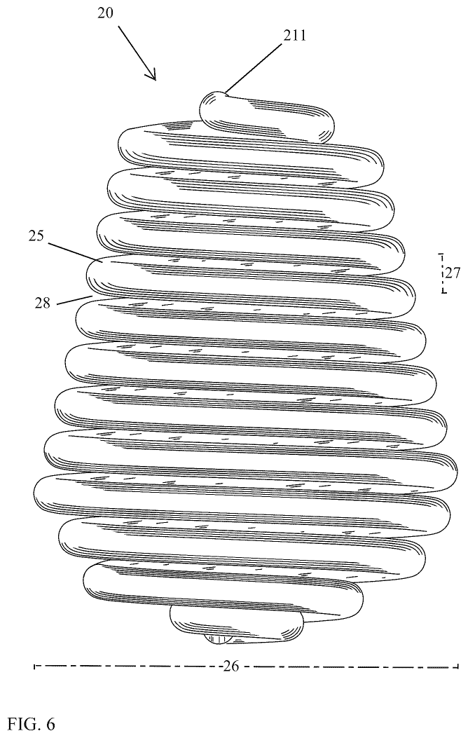

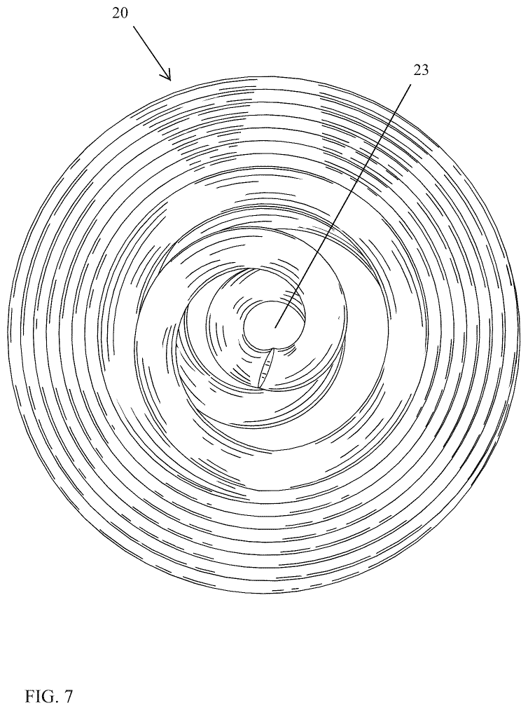

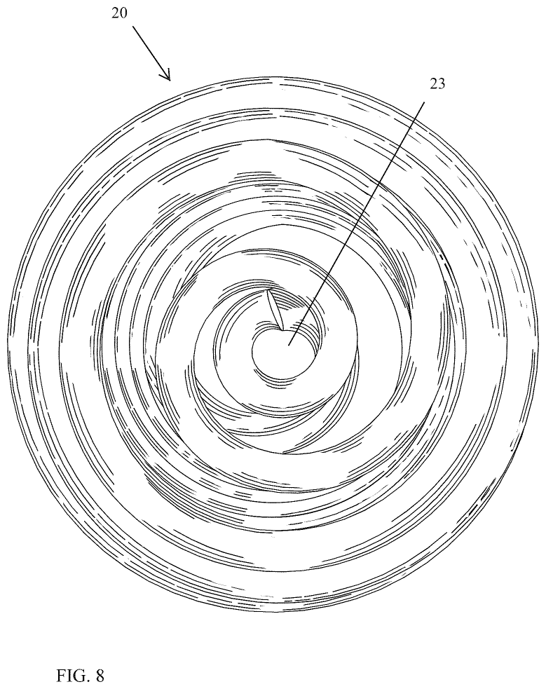

FIGS. 2-8 show one embodiment of the present invention and particularly a cone shaped helix 20. The cone shaped helix 20 is constructed of a rod-shaped material which begins at a first coil terminal 211 and has a plurality of turns 25 until ending at a second coil terminal 221. The turns 25 of the rod have a diameter 26 or width and the angle of the turn 25 in the rod defines a pitch 27, each of which can vary significantly from device to device. Depending on the material, the space 28 between the turns 25 may be wider or narrow, so long as the cooperation of the material and the space 28 permits the fishing line 1 to traverse the space 28. The diameter 26 and pitch 27 of the turns 25 may vary slightly but as visible in FIGS. 2-8, a conical embodiment will have a first end 211 diameter starting more narrow and with each turn the diameter gradually increases to a larger diameter occurring approximately three quarters the length of the device before returning to a narrow diameter at the second end 221. The larger and smaller diameter sections may also be inverted. It is also anticipated that the turns of helix could be right-handed or left-handed thereby turning in the opposite direction for installation.

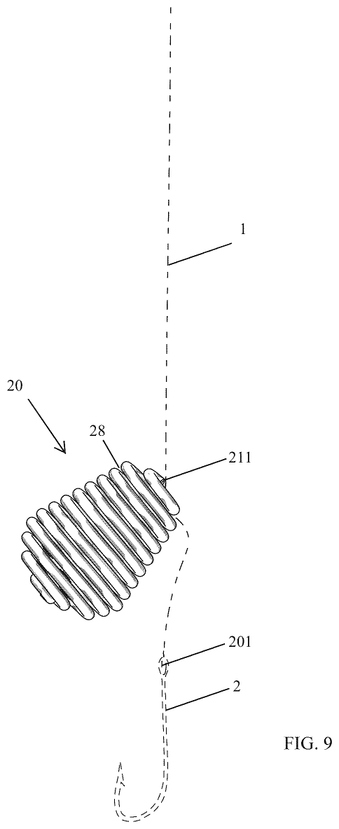

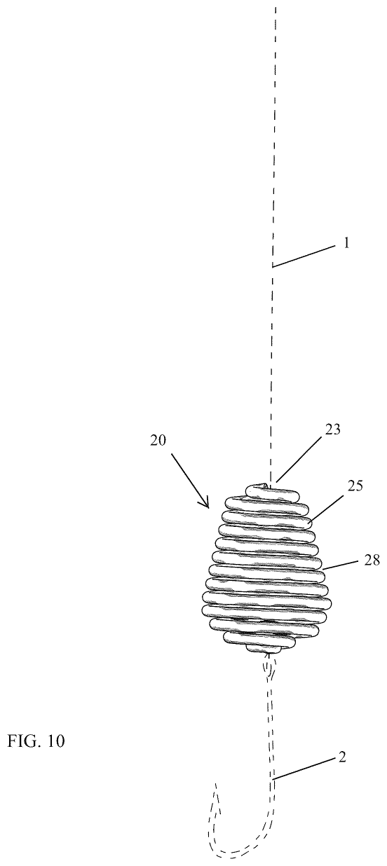

FIG. 9 shows the cone-shaped device 20 as it is being initially attached to the fishing line 1 by winding the line 1 between the turns 25 of the device. In the illustrated embodiment, the open slots or spaces 28 between the coils are visible. More particularly a fishing line 1 is placed inside the open first end 21 of the device, as shown in FIG. 9, when the helix is nearly perpendicular to the fishing line. The cone shaped helix 20 is then continually rotated until the fishing line 1 passes through the openings 28 between each turn 25 of the helix and the line 1 finally emerges from the bottom opening 22 of the spiral. The fishing line 1 is then captured within the center 23 of the helix 20 as shown in FIG. 10 and may move freely along the fishing line 1 until it abuts the hook 2 or other parts of the fishing rig. The interior diameter of the device channel 23 may abut the exterior diameter of the fishing hook eye 201 (not to scale) to define the relative range of distal movement of the device along the fishing line and relative placement above the bait or other lure.

With reference again to FIG. 1, the device 10 is diagrammatically demonstrated as the cone shaped helix of the invention during the intended use of fishing. The invention 10 and hook 2 are lightweight and would only be weighed down by adding additional weight, such as a sinker 4, to the fishing line 1 as illustrated to the left of the invention in FIG. 1.

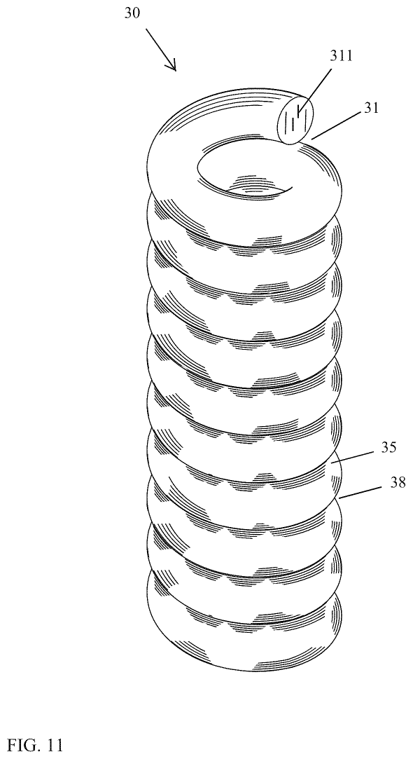

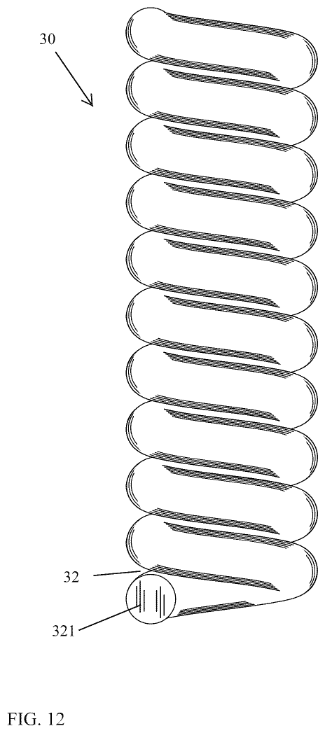

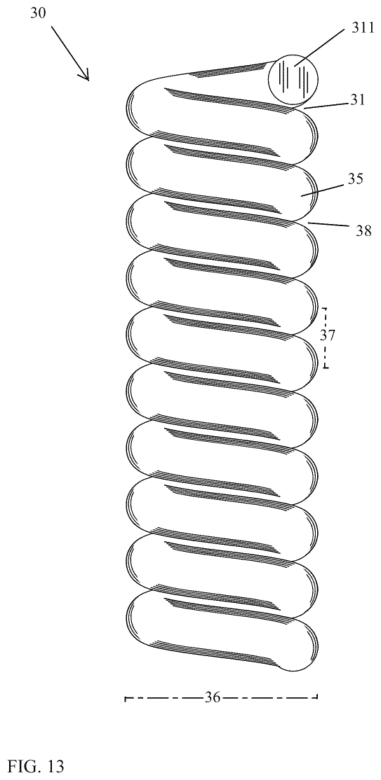

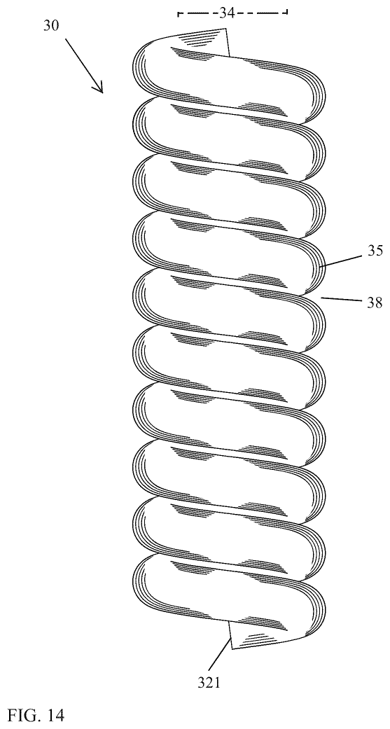

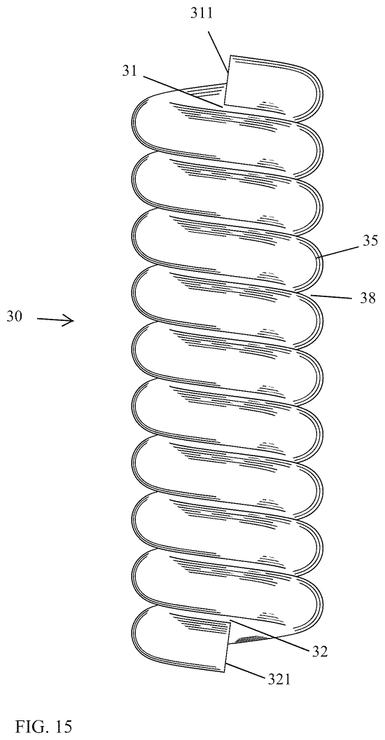

Turning to FIGS. 11-19, a second embodiment of the invention in a general shape of a columnar, tube-like coil 30 with a circular helix with a constant axial diameter 36 and pitch 37 is illustrated. The band curvature and torsion creating this helix are constant and therefore so are the open spaces 38. This embodiment is the most basic utilitarian helix and serves the purpose to surround the fishing line. The illustrated example has a number of turns 35 around the central axis and includes an open first end 31 and an open second end 32. The rod-shaped material ends in a first coil terminal 311 and a second coil terminal 321 (see FIG. 15).

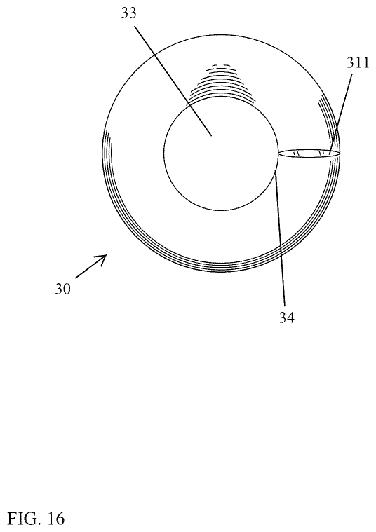

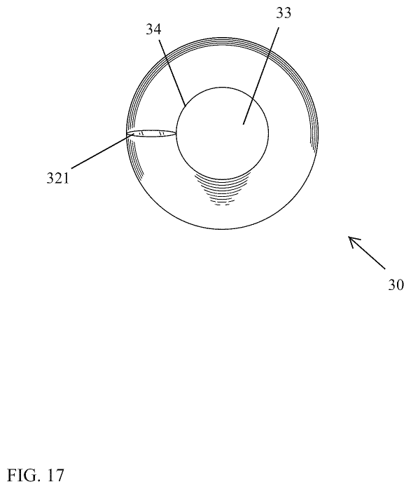

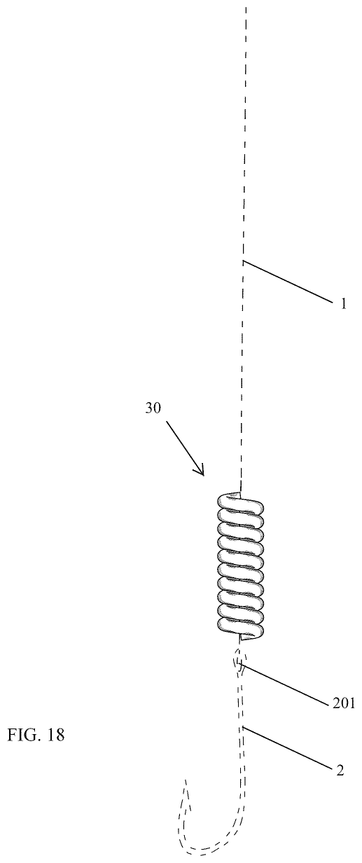

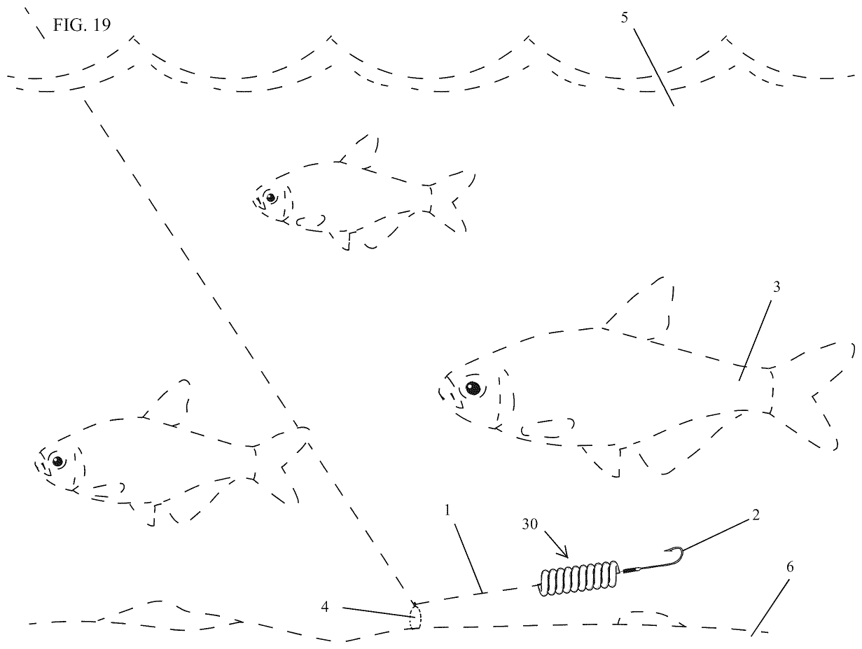

The end views of FIGS. 16-17 demonstrate the interior channel 33 created on the interior cavity of the tube-like coil 30. In some implementations of the device, the tubular coil is prevented from interfering with the hook 2 because the diameter 34 of the channel 33 is smaller than the exterior diameter of the hook eye 201 of the hook (see FIG. 18). Examples of a tubular embodiment 30 in use on a line 1 and with a hook 2 are reflected in FIGS. 18-19.

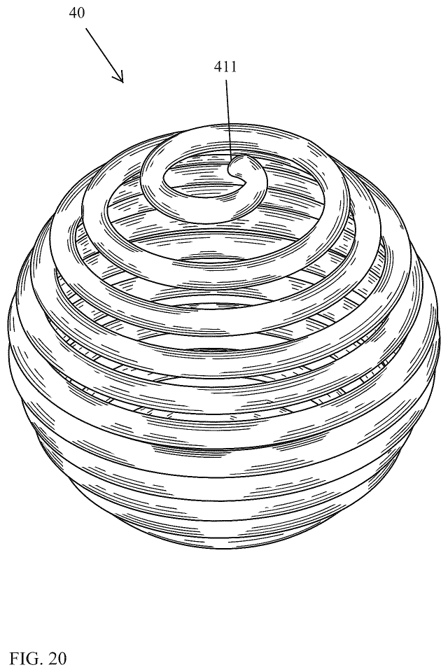

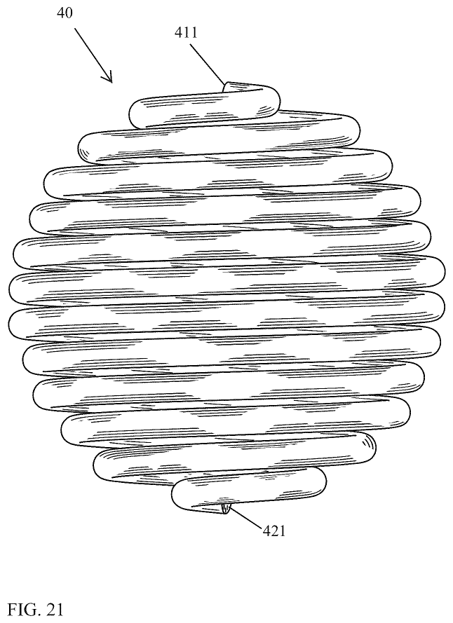

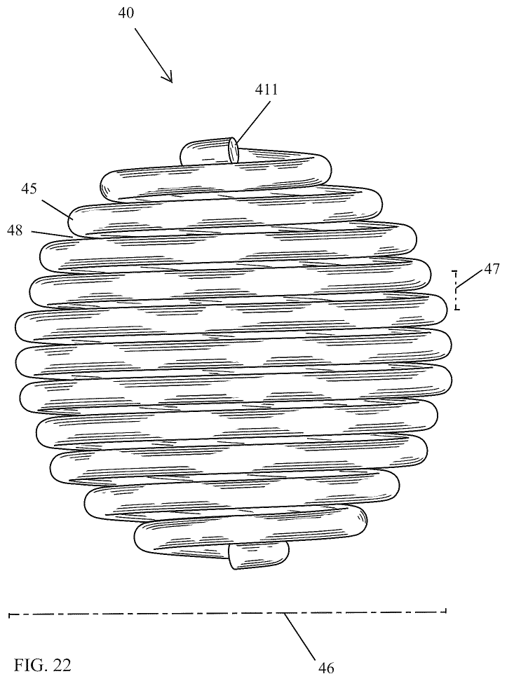

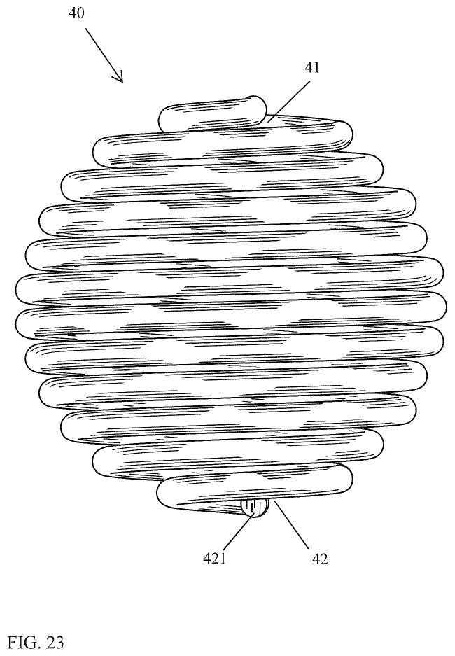

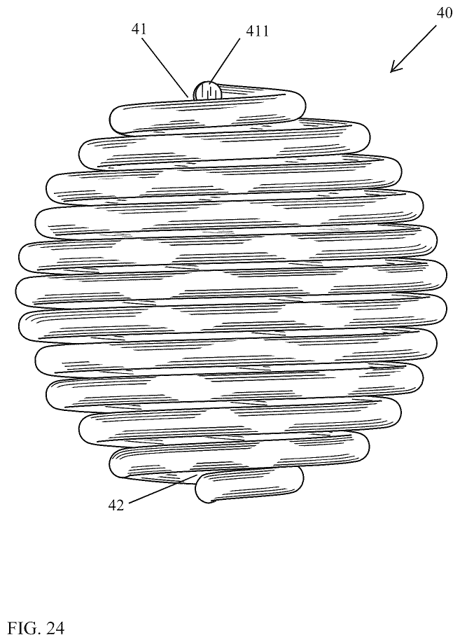

In yet another embodiment, the helical coil will be provided with a variable axial diameter such as the barrel coil 40. In the example coil embodiment shown in FIGS. 20-26, the coil is generally in the spherical shape of a barrel, with the widest diameter 46 occurring in the central portion of the device and the diameter tapering equally towards each of the first end and the second end. With reference to FIGS. 20-26, the particular example illustrated has a plurality of turns 45 around the central axis and includes an open first end 41 and an open second end 42. The rod-shaped material ends in a first coil terminal 411 and a second coil terminal 421.

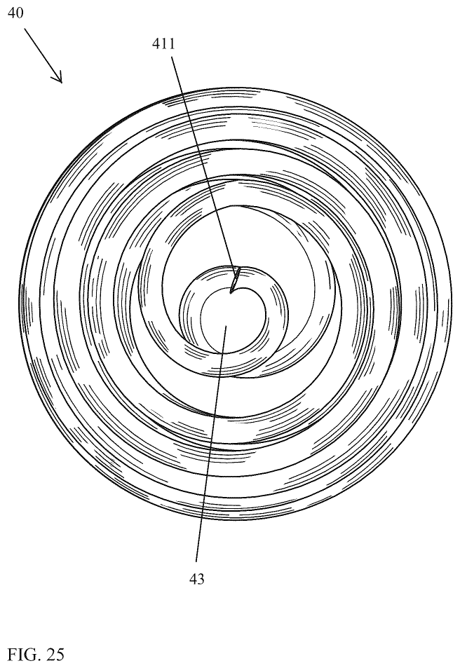

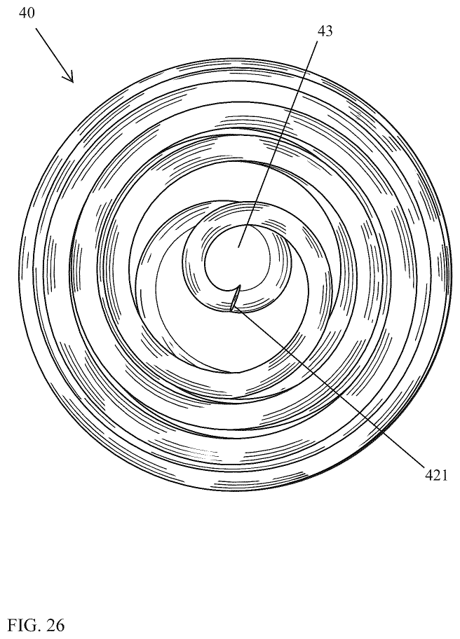

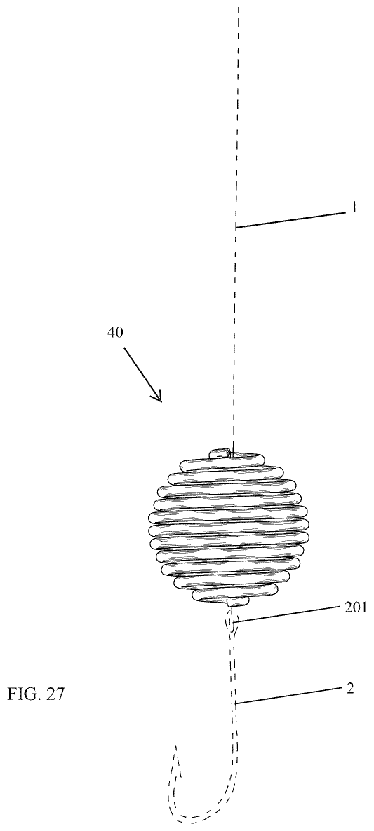

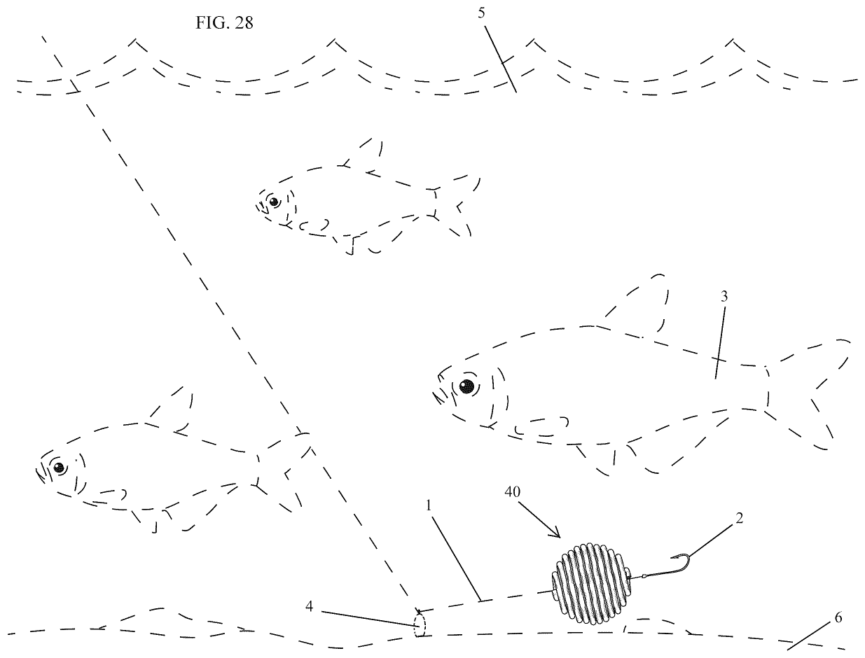

FIG. 25-26 demonstrate the interior channel 43 created on the interior cavity of the coil 40. In some implementations of the device, the coil 40 is prevented from interfering with the hook 2 because the diameter of the channel 43 is smaller than the exterior diameter of the hook eye 201 of the hook 2. Examples of the third embodiment 40 in use on a line 1 and with a hook 2 is reflected in FIGS. 27-28. The installation method for the second and third embodiments will be similar to that shown and described in FIG. 9.

This invention is useful in that it allows the attachment of colored/glow attractants upon the line of the fishing rig at any desired point in the length of the line without the necessity of cutting the fishing line or detaching the hook or any other parts of the fishing rig. When it comes time to change or remove the attractant, the fishing line is moved to the exterior of the first end and rotated in the opposite direction until passing through each helix turn and finally passing the second end to release completely from the fishing line. The process can be repeated as many times as desired without causing any damage to the fishing line and without removing the hook or other fishing accouterments.

In one example method of implementation, a winter lake fishing rig is provided with three, round split shot sinker weights approximately one foot from a hook tied to the end of the line and ready to receive bait. In some fishing rigs, this section of the rig may include a leader or tippet. A soft-silicon embodiment of the present invention is approximately one-half inch in length and has approximately a ⅜-inch diameter with a tight, but malleable pitch to the coil spring. The user notches a section of the otherwise rigged fishing line at one terminal end of the coil and begins twisting the coil around the mid-span section of line. The user continues to twist the coil until the line exits the coil at the second terminal end of the coil. The flexible nature of the coil permits the user to deform the turns of the coil slightly and make gaps for the line to slide easily from turn to turn of the coil after the line is notched into a first open end. Once the line has completed each turn and exited the coil at the second open end, the line is retained within the interior channel of the coil. In this example, bait, such as a worm, is added to the hook. The coil will slide loosely and freely in a longitudinal direction between the sinkers and the baited hook. During fishing, when the rig is placed in the water, the coil may rest next to the bait emitting glowing characteristics to attract the fish toward the worm. As demonstrated in FIG. 1, FIG. 19, and FIG. 28, at times during fishing, the coil may slide between the sinker and the hook or lure. Because the coil in this example is UV-charged to emit glow, after 20 minutes or so, the UV retention of the coil will be exhausted and new glow is needed to attract fish. When it is time for a freshly charged glowing attractant, the user will reel in the bait. The problem, normally for this type of fishing, is how to take the old glow off without cutting the line and re-rigging the hook and bait. With the present invention, the user removes the exhausted glow by once again notching the line through a terminal end of the coil and unwinding the device by twisting the line through the gaps between the coils until the line exits the second terminal end of the coil. Having a second coil charged with glow from the charger, the new coil is quickly applied to the line by repeating the earlier action of notching the line in the end and twisting the coil around the line. The bait is not removed, the hook is not detached, and the line is not cut and therefore there is no need for tying. This is particularly advantageous during winter fishing when finger dexterity and cold exposure is of utmost concern.

Regardless of the fishing body, the particular fishing technique, or the exact fishing rig used, the installation method and use of the various coils shown in FIGS. 1-10, and in FIGS. 11-19, and FIGS. 20-28 will be the same as described.

The invention provides convenience in the ability to change colors or glow materials without cutting the fishing line, tying knots, or fumbling around with additional parts. This invention is capable of being attached quickly to and detached quickly from the fishing line at any desired point along the fishing line.

This device can be attached to and removed from the fishing line without damage to the line and without harming the device itself.

The spiral device itself is made of flexible or rigid filament so long as it is at least semi-buoyant or lightweight. This filament may be solid or of a hollow tube of an illuminating substance of small diameter. The filament can be made of plastic, nylon, silicon, or other materials. It can vary depending upon preference of manufacturer and user.

The pitch of the helix may vary. The coil can be tightly wound resembling a spring or loosely wound resembling a corkscrew configuration. The overall width, length and shape may vary.

The filament used to make the device may vary in size, color and shape. The shape of the filament may be round, square, ribbon shaped, or any alternative shapes that will create a helix and allow the fishing line to pass between. The filament may be hollow for bearing luminescent material, but it could also be a solid color.

The coil may be constructed of high-tech glow additives that create luminous or glowing fishing implements with a full spectrum of glow colors. Some glow materials are energized or charged after being exposed to any source of UV light—sunlight, a black light, or a fluorescent light.

It is further intended that any other embodiments of the present invention which result from any changes in application or method of use or operation, method of manufacture, shape, size, or material which are not specified within the detailed written description or illustrations contained herein yet are considered apparent or obvious to one skilled in the art are within the scope of the present invention.

I claim:

1. A replaceable, suspended, buoyant attractant accessory for a fishing line comprising:
a coil having a first open end and a second open end and more than two turns,
wherein the coil receives the fishing line through the first open end and the coil is twisted until the fishing line traverses each turn and exits the second open end,
the fishing line being slidably retained, without being tied or cut, within a hollow cylinder defined by the coil during a fishing action, and
during the fishing action, the fishing line, encircled by the buoyant attractant accessory, is submerged such that the fishing line and a hook are held in a semi-buoyant arrangement under a body of water and at least one intervening fishing implement defines a slidable travel range along the fishing line for the buoyant attractant accessory.

2. The accessory of claim 1, wherein the coil is removed from the fishing line by a reversal of the twisting through the first open end without cutting or tying the fishing line.

3. The accessory of claim 1, wherein the hollow cylinder is configured with an interior diameter that is larger than the fishing line.

4. The accessory of claim 1, wherein the first open end and the second open end are each configured to receive the fishing line.

5. A floating accessory for fishing comprising:
a coil constructed of a pliable, buoyant material,
the coil having a multiple turns such turns defining a hollow cylinder and creating an interior diameter and an exterior diameter,
the coil terminating to form a first open end and a second open end,
wherein the floating accessory has fish attractant characteristics selected from a group consisting of colored or glowing or glow-charged attractants, and
wherein a fishing line is captured within the interior diameter after being transversely threaded through the first open end, wound around the multiple turns, and threaded out of the second open end, the fishing line submerging the floating accessory in a semi-buoyant arrangement under a body of water while at least one intervening fishing implement defines the proximal range of travel along the fishing line for the floating accessory.

6. The accessory of claim 5 wherein the coil is further constructed of material highly visible to fish in the body of water.

7. The accessory of claim 5, wherein the coil is further constructed of illuminating material to receive glow.

8. The accessory of claim 5, wherein the coil is constructed of material chosen from a group of flexible or rigid, solid or hollow filament.

9. The accessory of claim 5, wherein the coil illuminates.

10. The accessory of claim 5, wherein the coil is spiraled in the general shape of a cone.

11. The accessory of claim 5, wherein the coil is spiraled in the general shape of a columnar tube.

12. The accessory of claim 5, wherein the coil is spiraled in the general shape of a sphere.

13. The accessory of claim 5, wherein the coil is spiraled with a variable diameter.

14. The accessory of claim 13, wherein the variable diameter of the coil includes a central diameter larger than either end diameter portion of the coil.

15. The accessory of claim 5, wherein the interior diameter of the coil is larger than the fishing line.

16. The accessory of claim 5, wherein the interior diameter of the coil abuts the exterior diameter of a fishing hook eye.

17. The accessory of claim 5 wherein the at least one intervening fishing implement is chosen from a group of a weight, bead, hook, or lure.

18. A spherical helix, buoyant fishing accessory comprising:
a malleable coil having a first open end and a second open end and more than two tight turns,
wherein the malleable coil receives a fishing line through the first open end and the malleable coil is twisted around the tight turns until the fishing line traverses each tight turn and exits the second open end,
the fishing line being retained, without being tied or cut, within the coil during a fishing action,
during the fishing action, the fishing line positions the buoyant fishing accessory in a semi-buoyant arrangement under the water and at least one intervening fishing implement defines a proximal range of travel along the fishing line for the buoyant attractant accessory.

19. The fishing accessory of claim 18, wherein the malleable coil is removed from the fishing line by a reversal of the twisting through the first open end without cutting or tying the fishing line.

20. The fishing accessory of claim 18 wherein the buoyant fishing accessory is a buoyant fishing attractant held under the water by the fishing line.
